(19) United States
(12) Patent Application Publication
(10) Pub. No.: US 2026/0266197 A1
(43) Pub. Date: Sep. 10, 2026

(54) PART MADE OF CMC MATERIAL WITH PRE-CRACKED ENVIRONMENTAL BARRIER FOR THERMOMECHANICAL ACCOMMODATION

(71) Applicants: SAFRAN CERAMICS, LE HAILLAN (FR); CENTRE NATIONAL DE LA RECHERCHE SCIENTIFIQUE, PARIS (FR); UNIVERSITE DE BORDEAUX, BORDEAUX (FR)

(72) Inventors: Eric BOUILLON, MOISSY-CRAMAYEL (FR); Benjamin COSSOU, MOISSY-CRAMAYEL (FR); Simon ARNAL, MOISSY-CRAMAYEL (FR); Lisa PIN, MOISSY-CRAMAYEL (FR); Arthur DERRIEN, PARIS (FR); Sylvain Lucien JACQUES, TALENCE (FR)

(21) Appl. No.: 18/850,398

(22) PCT Filed: Mar. 23, 2023
(86) PCT No.: PCT/FR2023/050418

§ 371 Date: Sep. 24, 2024

(30) Foreign Application Priority Data
Mar. 25, 2022 (FR) 2202685

(51) Int. Cl. F01D 25/00; C04B 41/52; C04B 41/87; C04B 41/89

(52) U.S. Cl. CPC F01D 25/007; C04B 41/52; C04B 41/87; C04B 41/89; F01D 25/005; F05D 2260/95; F05D 2300/21; F05D 2300/6033; F05D 2300/611

(57) ABSTRACT

A coated part intended to be mounted in a turbomachine, includes a substrate of composite material with a matrix at least partially of ceramic, and an environmental barrier on the substrate and including (i) a bond coat layer including silicon present on a surface of the substrate, and (ii) an environmental barrier layer covering the bond coat layer, the environmental barrier layer including an inner region of barrier to oxidizing and corrosive species which is not cracked and located on the bond coat layer side, and an outer region, opposite the bond coat layer and covering the inner region, having a network of thermomechanical adaptation cracks having a distance between adjacent cracks included between 10 μm and 50 μm and having cracks extending over a depth included between 50% and 95% of the thickness of the environmental barrier layer.

### TECHNICAL FIELD

A particular field of application of the invention is the protection of composite materials with a matrix at least partially made of ceramic (“CMC materials”) forming hot parts of gas turbines, such as combustion chamber walls, turbine rings, turbine nozzles or turbine blades, for aircraft engines or industrial turbines.

### PRIOR ART

Improving efficiency and reducing pollutant emissions leads to considering increasingly higher temperatures in gas turbines.

It has therefore been proposed to replace metal materials by CMC materials, especially for walls of combustion chambers or turbine rings. In fact, CMC materials are known to possess both good mechanical properties enabling them to be used for structural elements and the ability to retain these properties at high temperatures. CMC materials require less cooling due to their improved resistance to high temperatures. Since this cooling is traditionally the result of extraction in the compressor that impacts the efficiency of the turbomachine, CMC materials therefore improve engine efficiency, which reduces fuel consumption. Furthermore, their use contributes to optimizing the performance of turbomachines, especially by reducing the overall mass of the turbomachine, which further contributes to a reduction in fuel consumption and therefore to a significant reduction in polluting emissions. The CMC materials can comprise a fibrous reinforcement made of refractory fibers, typically of carbon or ceramic, which is densified by a ceramic matrix, for example made of silicon carbide.

Under the operating conditions of aeronautical turbines, i.e., at high temperature in an oxidizing and humid atmosphere, CMC materials are sensitive to the phenomenon of corrosion. The corrosion of the CMC results from the oxidation of silicon carbide to silica which, in the presence of water vapor, volatilizes in the form of silicon hydroxides Si(OH)₄, Corrosion causes CMC recession and affects its service life. In order to limit this degradation in operation, it has been considered to form environmental barrier coatings (EBC) on the surface of CMC materials. Environmental barriers can comprise a silicon bond coat layer and a rare earth silicate layer positioned over the bond coat layer. The bond coat layer makes it possible, on the one hand, to improve the adhesion of the rare earth silicate layer and, on the other hand, to form a protective silica layer, the low oxygen permeability of which contributes to the protection of the CMC against oxidation. The rare earth silicate layer limits the diffusion of water vapor toward the silica layer formed by oxidation of silicon and consequently limits its recession.

Nevertheless, it remains desirable to further improve the protection of CMC materials in an oxidizing and corrosive environment at high temperature, especially greater than or equal to 800° C.

### DISCLOSURE OF THE INVENTION

The invention concerns a coated part intended to be mounted in a turbomachine, comprising:
a substrate of composite material with a matrix at least partially of ceramic, and
an environmental barrier on the substrate and comprising: (i) a bond coat layer comprising silicon present on a surface of the substrate, and (ii) an environmental barrier layer covering the bond coat layer, said environmental barrier layer comprising an inner region of environmental barrier to oxidizing and corrosive species which is not cracked and located on the bond coat layer side, and an outer region, opposite the bond coat layer and covering the inner region, having a network of thermomechanical adaptation cracks having a distance between adjacent cracks comprised between 10 μm and 50 μm and having cracks extending over a depth comprised between 50% and 95% of the thickness of said environmental barrier layer.

The inventors have found that the environmental barriers of the prior art may exhibit uncontrolled cracking during operation, which is explained by the fact that the barrier is initially, as soon as it is manufactured, under compression. This compressive stress relaxes by creep when subjected to the high temperatures encountered in operation, which then leads to cracking during cooling due to a return to a tensile field. This cracking can reach the bond coat layer, which leads to uncontrolled growth of the protective silica layer and can cause flaking of the environmental barrier by increasing localized stresses at the interface of the bond coat layer with the environmental barrier layer. Remarkably, the inventors have found that the use of an environmental barrier, pre-cracked in a controlled manner before its first use with a controlled distance between adjacent cracks and a controlled depth of cracking, makes it possible to favorably accommodate thermomechanical stresses in operation. The thermomechanical adaptation crack network prevents uncontrolled cracking of the barrier by dissipating energy via the pre-existing network of cracks, while maintaining an uncracked inner region giving the desired sealing to oxidizing and corrosive species in order to control the growth of the protective silica layer and avoid flaking.

In one embodiment, the distance between adjacent cracks of the thermomechanical adaptation crack network is comprised between 15 μm and 30 μm.

Such a characteristic contributes to further improving the accommodation of thermomechanical stresses in operation.

In an example embodiment, the cracks of the thermomechanical adaptation crack network extend over a depth comprised between 75% and 90% of the thickness of said environmental barrier layer.

Such a characteristic contributes to further improving the accommodation of thermomechanical stresses in operation, while conferring an optimal seal to oxidizing and corrosive species, provided by the inner region.

In an example embodiment, the environmental barrier layer comprises a silicate of at least one rare earth, in particular the environmental barrier layer can comprise an yttrium disilicate, an ytterbium disilicate, or a mixture of these two compounds. According to one variant, the environmental barrier layer comprises mullite.

In an example embodiment, the part further comprises an additional coating located on the outer region of the environmental barrier layer, said additional coating being a thermal barrier having a thickness greater than or equal to 100 μm, or a protective layer against calcium and magnesium aluminosilicates having a thickness greater than or equal to 50 μm.

Such a characteristic advantageously makes it possible to further functionalize the protective coating and thus improve the protection conferred.

In an example embodiment, the inner region and the outer region of the environmental barrier layer are made of the same material.

Such a characteristic advantageously optimizes the thermomechanical compatibility between the two regions and thus optimizes the control of the pre-cracking of the environmental barrier.

In particular, the inner and outer regions of the environmental barrier layer can be yttrium disilicate, ytterbium disilicate, or a mixture of these two compounds.

### BRIEF DESCRIPTION OF THE DRAWINGS

FIG. 1 schematically and partially represents an example of a part coated according to the invention.

FIG. 2 schematically and partially represents a precursor deposit of the environmental barrier layer of the part of FIG. 1.

FIG. 3 schematically and partially represents the effect of a cracking heat treatment on the precursor deposit of FIG. 2.

FIG. 4 is an image of an example of an environmental barrier layer usable in the context of the invention obtained after cracking treatment of a precursor deposit.

### DESCRIPTION OF THE EMBODIMENTS

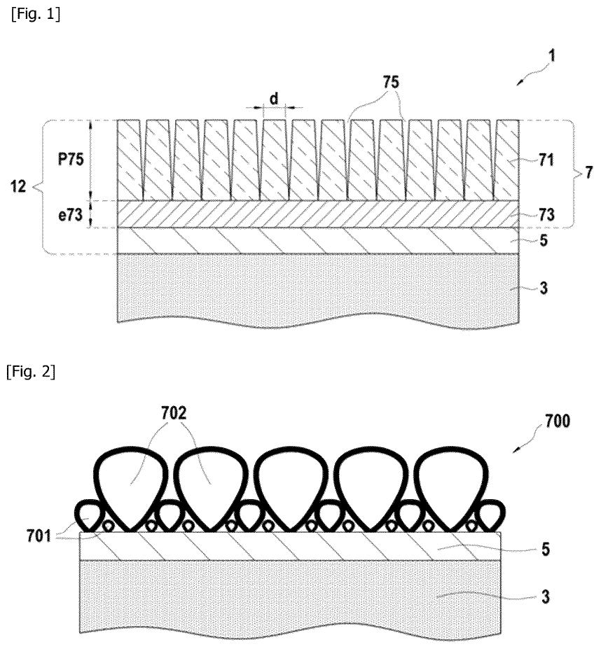

FIG. 1 shows an example of the part 1 comprising a CMC material 3 provided with an environmental barrier 12. The CMC material 3 can comprise a fibrous reinforcement which can be of carbon (C) fibers or ceramic fibers, for example silicon on carbide (SiC) fibers or formed essentially of SiC, including Si—C—O or Si—C—O—N fibers, i.e., also containing oxygen and possibly nitrogen. Such fibers are produced by NGS under the reference “Nicalon” or “Hi-Nicalon” or “Hi-Nicalon Type-S”, or by UBE Industries under the reference “Tyranno-ZMI”. The ceramic fibers can be coated with a thin interphase layer of pyrolytic carbon (PyC), boron nitride (BN) or boron-doped carbon (BC, with 5% to 20% of B, the balance being C). The fibrous reinforcement is densified by an at least partially ceramic matrix, for example predominantly ceramic by volume. The ceramic matrix can comprise silicon carbide or a ternary Si—B—C system, for example. The matrix can be at least partly formed by CVI in a manner known per se. Alternatively, the matrix can be formed at least in part by liquid means (impregnation with a matrix precursor resin and transformation by crosslinking and pyrolysis, the process being repeatable) or by silicon infiltration in the molten state (melt-infiltration method). In the latter case, a powder is introduced into the optionally partially densified fibrous reinforcement, this powder possibly being a carbon powder, a ceramic powder (for example silicon carbide), or a mixture of such powders, and a silicon-based metallic composition in the molten state is then infiltrated to form a matrix of the SiC—Si type. The fibrous reinforcement may or may not be woven; it would not exceed the scope of the invention when the fibrous reinforcement is in the form of short fibers dispersed in the material 3.

Alternatively, it is possible to use a particulate reinforcement in the form of grains dispersed in the material 3.

The environmental barrier 12 can be formed over the entire external surface S of the CMC material 3 or over only a portion of this surface S, for example when only a portion of the surface S needs to be protected. The environmental barrier 12 comprises a bond coat layer 5 and an environmental barrier layer 7 covering the bond coat layer 5. In the example illustrated, the bond coat layer 5 is present in contact with the surface S of the composite material 3. Furthermore, in this example, the layer 7 is in contact with the bond coat layer 5. In operation, the bond coat layer 5 can form, in a manner known per se, a silica layer that protects against oxidation, the so-called thermally grown oxide (TGO) layer. The bond coat layer 5 can be made of silicon.

The layer 7 provides protection against oxidation and corrosion at high temperature especially by limiting the diffusion of water vapor and oxygen toward the bond coat layer 5 and the CMC material 3. The layer 7 can comprise a rare earth silicate, for example a rare earth monosilicate and/or a rare earth disilicate. The layer 7 can comprise at least one rare earth element chosen from yttrium Y, scandium Sc and lanthanides. In particular, the rare earth element can be chosen from yttrium Y and ytterbium Yb. It will be noted that it would not exceed the scope of the invention if the layer 7 comprises several rare earth elements, for example yttrium and ytterbium.

FIG. 1 shows an environmental barrier layer 7 which comprises an inner region 73 which is not cracked and located on the side of the bond coat layer 5. The inner region 73 confers a seal to oxidizing and corrosive species. The region 73 can be situated in contact with the bond coat layer 5. The layer 7 further comprises an outer region 71, opposite the bond coat layer 5, and having a network of cracks 75 for thermomechanical adaptation. Region 73 and region 71 can be made of the same material, for example yttrium disilicate, ytterbium disilicate, or a mixture of these two compounds. Details of the formation of environmental barrier 12 will be described below. The outer region 71 covers the inner region 73. The cracks 75 extend over the entire thickness of the region 71 to the region 73 which is not cracked. The network of cracks 75 can extend over the entire area of region 71. The network of cracks 75 has a controlled distance d between adjacent cracks comprised between 10 μm and 50 μm, preferably between 15 μm and 30 μm. In particular, the mean distance between adjacent cracks 75 is comprised between 10 μm and 50 μm, preferably between 15 μm and 30 μm. In general, the distance d between adjacent cracks can be regular on the layer 7 and correspond to a cracking increment. Alternatively, this distance d can be variable between different pairs of adjacent cracks, while still being comprised between 10 μm and 50 μm, preferably between 15 μm and 30 μm, for all the cracks 75 present. According to one example, the set of distances d between adjacent cracks can be comprised between m/2 and 2 m, where m denotes the mean distance between adjacent cracks 75. The cracks 75 can each extend over a depth p75 comprised between 50% and 95%, preferably between 75% and 90%, of the thickness e7 of the environmental barrier layer 7. The cracks 75 do not reach the bond coat layer 5 and make it possible to preserve the internal sealing region 73 in order to control the growth of the protective silica layer in operation, and to prevent chipping. The thickness e7 of the layer 7 can be greater than or equal to 50 μm, for example greater than or equal to 200 μm, for example greater than or equal to 250 μm. This thickness e₇ can be comprised between 50 μm and 1000 μm, for example between 200 μm and 1000 μm or between 250 μm and 1000 μm, for example between 200 μm and 700 μm or between 250 μm and 700 μm. In general, the thickness e73 of the inner sealing region 73 can be comprised between 1 μm and 10 μm, for example between 2 μm and 5 μm. If this is desired, an additional thermal barrier or CMAS protection coating can be deposited on the region 71, in a manner known per se, or the region 71 can define an external surface of the coated part 1.

The details relating to the manufacture of the coating on the CMC material 3, in particular concerning the formation of the bond coat layer 5 and of the environmental barrier layer 7, will now be described.

The bond coat layer 5 can be formed by chemical vapor deposition from a precursor comprising silicon comprising, for example, a silane, a monochlorosilane, a dichlorosilane and/or a trichlorosilane. Two examples of formation of the bond coat layer 5 by chemical vapor deposition are described below.

According to a first example, the temperature imposed during the deposition of the bond coat layer 5 can be comprised between 900° C. and 1150° C., for example between 1100° C. and 1150° C., and the pressure imposed during this deposition can be comprised between 15.3 kPa and 20 kPa, for example between 16.7 kPa and 18 kPa. During deposition, the precursor comprising silicon can be introduced into the reaction chamber in which the CMC material 3 is present at a flow rate comprised between 0.05 gram/minute and 0.3 gram/minute, for example between 0.1 gram/minute and 0.2 gram/minute. According to this first example, the bond coat layer 5 obtained has a crystalline microstructure. In particular, the bond coat layer 5 can be made of silicon, this bond coat layer 5 comprising, for example, columnar grains of crystalline silicon. Alternatively, the bond coat layer 5 can be made of silicon alloy, for example a eutectic silicon alloy or silicide.

According to a second example, the bond coat layer 5 comprises an amorphous silicon phase having crystalline silicon grains distributed inside, these grains possibly having a mean size comprised between 0.03 μm and 3 μm. The amorphous silicon phase can be formed of pure silicon or silicon with boron, oxygen and/or nitrogen dispersed therein. According to this second example, the bond coat layer 5 can be formed at a deposition temperature which prevents crystallization of the deposited silicon, followed by a heat treatment of the bond coat layer at a treatment temperature higher than the temperature imposed during deposition in order to form the crystalline silicon grains distributed in the amorphous silicon phase. The temperature imposed during deposition can be comprised between 300° C. and 700° C. or between 700° C. and 1000° C., and the pressure imposed during deposition can be comprised between 1.2 kPa and 1,013 hPa. The operating conditions are chosen as a function of the precursor used. The treatment temperature can be comprised between 1000° C. and 1400° C., for example between 1200° C. and 1350° C. During deposition, the precursor comprising silicon can be introduced into the reaction chamber in which the CMC material 3 is present at a flow rate comprised between 0.1 gram/minute and 2 gram/minute. The person skilled in the art will recognize that the bond coat layer 5 can be formed by other techniques.

In general, the environmental barrier layer 7 can be formed by implementing the following steps:
(a) deposition of a precursor layer by chemical vapor deposition of organometallic compound(s) (metal organic chemical vapor deposition, MOCVD), optionally by chemical vapor deposition of organometallic compound(s) by direct liquid injection (DLI-MOCVD), then
(b) cracking treatment of the precursor layer deposited in step (a) by subjecting it to a temperature comprised between 1250° C. and 1350° C. for a period comprised between 5 hours and 50 hours, for example, between 10 hours and 50 hours. According to one example, the deposition of the precursor layer carried out during step (a) can comprise a silicate of at least one rare earth and is formed at least from an alkoxysilane silicon oxide precursor and a rare earth beta-diketonate rare earth oxide precursor in the presence of an oxygen-supplying gaseous source. In particular, the silicon oxide precursor can be di-t-butoxydiacetoxysilane and the rare earth oxide precursor RE(thd)₃, where RE denotes a rare earth element and the (thd) group denotes 2,2,6,6-tetramethyl-3,5-heptanedionate, the rare earth oxide precursor being, for example, Y(thd)₃ (CAS No. 15632-39-0). The oxygen-supplying gas source can contain at least one of the following gases: O₂, N₂O, H₂O, CO₂, O₃.

The temperature imposed during step (a) can be comprised between 1000° C. and 1250° C. The cracking treatment of step (b) can be carried out in an oxidizing atmosphere, for example in air.

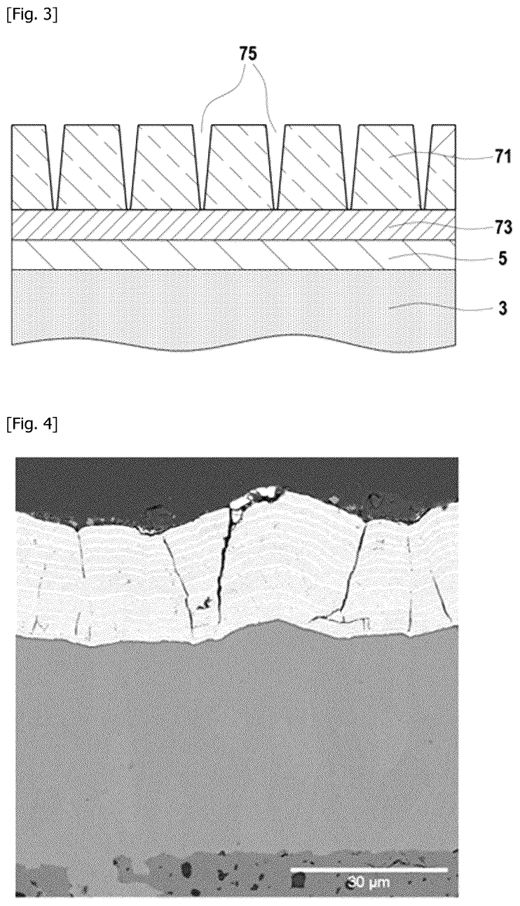

FIGS. 2 and 3 schematically represent the deposit obtained after steps (a) and (b) respectively. After step (a), the deposit 700 has a microstructure with growth cones with a first portion 701 located on the side of the bond coat layer 5 formed by first contiguous growth cones having a first mean size, and a second portion 702 formed by second growth cones having a second mean size, greater than the first mean size, and having a smaller compactness than the first growth cones. According to one example, it is possible to obtain a deposit 700 of an alpha phase of yttrium disilicate during step (a). During step (b), the structure illustrated in FIG. 3 is obtained with preferential cracking at the junctions of the growth cones 702 while guaranteeing the seal of the coating at the interface with the bond coat layer 5 by the presence of the non-cracked inner region 73 obtained from the cones 701. The heat treatment of step (b) can cause sintering of the coating, which leads to coalescence of the growth cones 701, smaller in size but larger in number in the area close to the interface with the bond coat layer 5, thus leading to the formation of a sealed region 73. The heat treatment of step (b) can also cause a volume contraction, for example due to a transition between the alpha phase and the beta phase of the yttrium disilicate in the case where it is used, which results in preferential cracking at the junctions of the growth cones 702.

The part 1 thus manufactured can be a part for aeronautical or aerospace application. The part 1 can be a hot part of a gas turbine of an aeronautical or aerospace engine or an industrial turbine. The part 1 can be a turbomachine part. The part 1 can constitute at least part of a distributor, at least part of a nozzle or of a thermal protection coating, a wall of a combustion chamber, a turbine ring sector or a turbomachine blade.

Once obtained, the part 1 is mounted and assembled to the other components of the turbomachine in order to be used at high temperature, greater than or equal to 800° C., in an oxidizing and corrosive atmosphere. It can, in particular, be used at a temperature comprised between 800° C. and 1500° C., or between 800° C. and 1300° C. The part 1 can, in particular, be used in humid air.

### EXAMPLE

A precursor deposition was carried out in a reactor for chemical vapor deposition of organometallic compound(s) by direct liquid injection (DLI-MOCVD) with hot walls, from a solution of di-t-butoxydiacetoxy silane (DADBS) and tris(2,2,6,6-tetramethyl-3,5-heptanedionato) yttrium (Y(thd)₃), diluted in toluene. The precursors are injected and vaporized using a thermostatically controlled direct liquid injection system marketed under the reference Vapbox 300 by the company KEMSTREAM, using injectors of the car engine type to form an aerosol. After preparation, the precursor deposit was heat treated for 5 hours at 1350° C. in air. During this heat treatment, the deposit went from the alpha phase in the precursor deposit to the beta phase, causing regular microcracking of the upper part of the coating.

Details of the conditions of development are provided below:
deposition temperature: 1030° C.,
deposition pressure: 5 mbar,
DADBS concentration: 0.1 mol/L,
Y(thd)₃ concentration: 0.15 mol/L,
precursor solution flow rate: 0.1 g/minute,
O₂ flow rate: 54 standard cubic centimeters (sccm) per minute,
N₂ flow rate: 200 standard cubic centimeters per minute,
injector frequency: 2 Hz,
precursor evaporation temperature: 210° C.

The deposit obtained after the cracking heat treatment is illustrated in FIG. 4. The coating obtained passed 1500 hours of corrosion testing without degradation. The interface with the bond coat layer did not change during the corrosion test. This result confirms that the small thickness of the sealed part of the environmental barrier is sufficient to ensure resistance to chipping. In addition, the pre-cracking network is quite repetitive.

More generally, the following ranges of conditions can be used for deposition of the precursor layer:
deposition temperature: 1000° C. to 1250° C.,
deposition pressure: 5 mbar,
DADBS concentration: 0.01 mol/L to 0.1 mol/L,
Y(thd)₃ concentration: 0.015 mol/L to 0.15 mol/L,
precursor solution flow rate: 0.1 g/minute to 2 g/minute,
O₂ flow rate: 25 to 200 standard cubic centimeter per minute,
N₂ flow rate: 100 to 400 standard cubic centimeters per minute,
injector frequency: 0.5 Hz to 3 Hz,
precursor evaporation temperature: 170° C. to 250° C.,
potentially applicable also in a reactor in cold-wall configuration.

The expression “comprised between . . . and . . . ” should be understood to include the bounds.

1. A coated part intended to be mounted in a turbomachine, comprising:
a substrate of composite material with a matrix at least partially of ceramic, and
an environmental barrier on the substrate and comprising: (i) a bond coat layer comprising silicon present on a surface of the substrate, and (ii) an environmental barrier layer covering the bond coat layer, said environmental barrier layer comprising an inner region of barrier to oxidizing and corrosive species which is not cracked and located on the bond coat layer side, and an outer region, opposite the bond coat layer and covering the inner region, having a network of thermomechanical adaptation cracks having a distance between adjacent cracks comprised between 10 μm and 50 μm and having cracks extending over a depth comprised between 50% and 95% of a thickness of said environmental barrier layer, wherein the inner region and the outer region of the environmental barrier layer are made of the same material.

2. The part according to claim 1 wherein the distance between adjacent cracks of the thermomechanical adaptation crack network is comprised between 15 μm and 30 μm.

3. The part according to claim 1, wherein the cracks of the thermomechanical adaptation crack network extend over a depth comprised between 75% and 90% of the thickness of said environmental barrier layer.

4. The part according to claim 1, wherein the environmental barrier layer comprises a silicate of at least one rare earth.

5. The part according to claim 4, wherein the environmental barrier layer comprises yttrium disilicate, ytterbium disilicate, or a mixture of these two compounds.

6. The part according to claim 1, wherein the part further comprises an additional coating located on the outer region of the environmental barrier layer, said additional coating being a thermal barrier having a thickness greater than or equal to 100 μm, or a protective layer against calcium and magnesium aluminosilicates having a thickness greater than or equal to 50 μm.

7. (canceled)

8. The part according to claim 1, wherein the inner region and outer region of the environmental barrier layer are in yttrium disilicate, ytterbium disilicate, or a mixture of these two compounds.
